(19) United States
(12) Patent Application Publication
(10) Pub. No.: US 2014/0236625 A1
(43) Pub. Date: Aug. 21, 2014

(54) SOCIAL NETWORK TECHNIQUES APPLIED TO THE USE OF MEDICAL DATA

(71) Applicant: COVIDIEN LP, Mansfield, MA (US)

(72) Inventor: Robert Hartman, San Marcos, CA (US)

(73) Assignee: COVIDIEN LP, Mansfield, MA (US)

(21) Appl. No.: 13/768,419

(22) Filed: Feb. 15, 2013

(51) Int. Cl. G06Q 50/00; G06F 19/00

(52) U.S. Cl. CPC G06Q 50/01; G06F 19/32
USPC 705/3

(57) ABSTRACT

A method for indentifying a clinician team using a computer system including accessing a social graph with nodes for each clinician in a medial institution and collecting patient data from patients treated by the medical institution. Edges are created between patient nodes and element nodes corresponding to patient data. Edges are also created between each element node the clinician node of each treating clinician. Additional edges are created by monitoring the usage of patient data by each clinician. A weight is assigned to each connection between each of the nodes. A data set is created which scores each clinician node with respect to a chosen node. Each clinician with a clinician node with a score over a threshold score is displayed. The display may automatically form a team of clinicians.

### TECHNICAL FIELD

The present disclosure relates generally to the use of social networking techniques in a medical institution, more specifically identifying a team of clinicians from the clinicians at a medical institution using a social graph with a set of nodes and a set of edges that establish relationships between the nodes.

### BACKGROUND

A traditional social graph is a social structure made of individuals, groups, entities, or organizations generally referred to as “nodes.” Which are connected by one or more specific types of interdependency. Social graph analysis views social relationships in terms of network theory consisting of nodes and edges. Nodes are the individual actors or data points and edges are the relationships between the nodes. The resulting network-based structures are often very complex. There can be many kinds of edges between nodes. In its simplest form, a social graph or social network is a map of all of the relevant edges between all the nodes being studied.

Social graphs are generally hosted on computer systems. The computer systems are connected to various local and wide area computer networks allowing users to interact with the information located on various computer systems. Users may enter personal information, view information about others, search for information, and update information about others.

### SUMMARY

This disclosure relates to a method, a system, and a program that use social networking techniques to identify teams of clinicians within a medical institution.

The method includes accessing a social graph with a computer system including a clinician node for each clinician in the institution. An edge is created for each organizational (formal) relationship and each professional (informal) relationship between the clinicians. Patient data is collected for each patient treated at the institution and entered into the computer system. The computer system associates each patient with a patient node in the social graph. Then the computer system creates an edge between each patient node and an element node which corresponds to each element of patient data corresponding to the patient. The computer system creates another edge between each patient node and the clinician node corresponding to the treating clinician. The computer system creates another edge between each element node of patient data and each clinician node corresponding to the treating clinician. The computer system also monitors each usage of the patient data by each clinician and creates an edge between each clinician node and the element node of patient data. Next, the computer system assigns a weight to each connection between the nodes. The weight of each connection relates to the number of edges connecting each node either directly or indirectly through intermediate nodes. The weighting may relate to the characteristics of each edge. The computer system can be configured to give greater weight to edges possessing certain characteristics. For example, formal organizational relationships may be weighted more heavily than informal professional relationships. The computer system creates a first data set that scores each clinician node that is connected to a chosen node. The computer system displays each clinician that corresponds to a clinician node with a score over a threshold score. Each displayed node may be ranked by the score.

The present disclosure can also be embedded in a computer program product, which comprises all the features enabling the implementation of the methods described herein, and which when loaded in a computer system is able to carry out these methods.

By identifying teams of clinicians, relationships between the clinicians may be improved from the identification of unknown similarities by particular clinicians. When a team of clinicians is identified, the team may be assembled as a clinical team for a given patient, a group of patients, an advisory board for a particular condition, a panel discussion, or more informal teams such as a luncheon. By identifying teams of clinicians and improving clinician relationships, either professional relationships or non-professional relationships, the communication between clinicians will be improved. The improvement in communication may result in improved clinical knowledge among the clinicians and ultimately improved patient outcomes. The dynamic and organic nature of the development of teams by these methods may result in the creation of teams that transcend formal organizational boundaries to provide a level of care that might otherwise be limited by those formal boundaries. The identification of these teams may provide valuable insights leading to revisions of an institution's formal organizational structure, resulting in new organizational structures that are optimized for patient care and improved outcomes. Identifying teams of clinicians may also allow patients to identify a team of clinicians which have experience or expertise with a particular element of patient data. This identified team may he used to form a specialized team to treat the patient or for the patient to seek a second opinion. Identifying a team of clinicians with experience or expertise with a particular element of patient data may also be used by the institution to form a research team for the element of patient data such as a specific disease.

Certain embodiments of the present disclosure may include some, all, or none of the above advantages. One or more other technical advantages may be readily apparent to those skilled in the art for the figures, descriptions, and claims included herein. Moreover, while specific advantages have been enumerated above, various embodiments may include all, some, or none of the enumerated advantages.

### BRIEF DESCRIPTION OF THE DRAWINGS

There are shown in the drawings embodiments, which are exemplary, it being understood that the disclosure is not limited to the precise arrangements and instrumentalities shown.

FIG. 1 is an example of computer system architecture.

FIG. 2 is an example of integrated system architecture.

FIG. 3 is an example of network architecture.

FIG. 4 is an example of a portion of a social graph.

FIG. 4A is a flowchart illustrating a method with may be used to create the portion of a social graph illustrated in FIG. 4.

FIG. 5A is an example of another portion of the social graph of FIG. 4.

FIG. 5B is an example of another portion of the social graph of FIG. 4.

FIG. 5C is a flowchart illustrating methods with may be used to create the portions of a social graph illustrated in FIGS. 5A and 5B.

FIG. 6 is an example of another portion of the social graph of FIG. 4.

FIG. 6A is a flowchart illustrating a method with may be used to create the portion of a social graph illustrated in FIG. 6.

FIG. 7 is an example of groups of edges connected to a chosen node.

FIG. 7A is an example of a data set.

FIG. 7B is a flowchart illustrating a method with may be used to create data set illustrated in FIG. 7B.

FIG. 8A is an example of a display showing patient data.

FIG. 8B is another example of a display showing patient data.

FIG. 8C is an example of a display showing patient data received from a medical device.

FIG. 9 is an example of a display.

FIG. 10 is an illustration of an example of a method for identifying a team of clinicians.

### DETAILED DESCRIPTION

The disclosure herein provides among other things a method, system, and a program for identifying a team of clinicians in a medial institution. In this disclosure, the system can interpret the data streams sent from specified machines and transport the information contained within the data streams to a networked element. This networked element can transform the information into a machine-independent data schema. The information provided by medical devices monitoring or treating patients and other patient data, such as pharmacological data and laboratory results can be integrated within a single presentation device. For example, patient data can be physiologic, laboratory, pharmacy, and other patient-centric data for a given patient. Additionally, physiologic data can be analyzed by other health-related systems. For example, clinical research facilities can access stored patient data that has been sanitized so that patient privacy information and identification has been removed.

As used herein, bedside refers to an environment in close proximately to a patient being treated. Items placed within a bedside environment should be near enough to the patient that a physician treating the patient can access the items while treatment is being performed. It should be noted that a bedside environment need not include a bed. For example, instead of a bed, a patient can be contained within an incubator, an ambulance, a gurney, a cot, an operating table, and the like. Similarly, an apparatus that can provide information to an individual, such as a physician, located within the bedside environment can be considered bedside apparatus even if necessary portions of the apparatus are in a location remote from the patient (e.g., servers, databases, etc.). As used herein, clinician refers to any personal at a medial institution including but not limited to physicians, nurses, laboratory technicians, and administrators. As used herein, medical institution refers to any singular or group of medical providers providing medical services to patients including but not limited to hospitals, clinics, medical research facilities, or hospital networks.

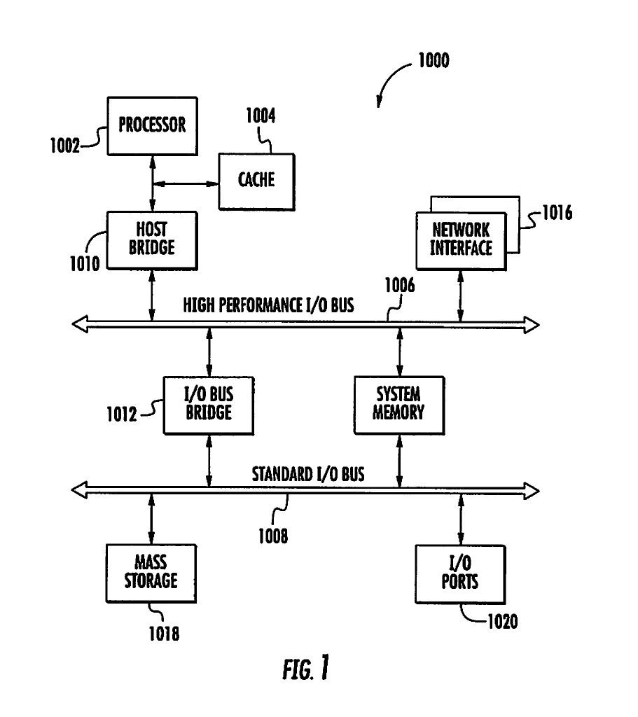

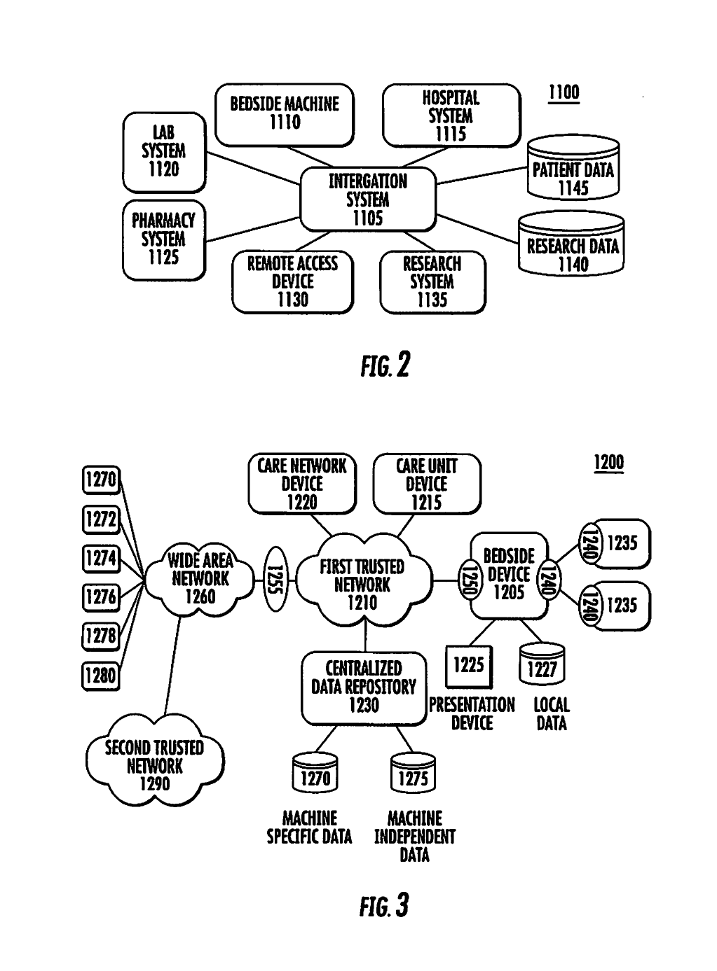

Referring now to FIGS. 1-3, an example of a system for performing a method is disclosed. A computer system 1000 performs at least one step of the method and includes a processor 1002. Computer system 1000 may also include a mass storage component 1018, a presentation device 1225, and a network interface 1016. Two or more computer systems 1000 may be interlinked using known networking techniques to form a network 1200 as shown between computer systems 1270-1280 in FIG. 3.

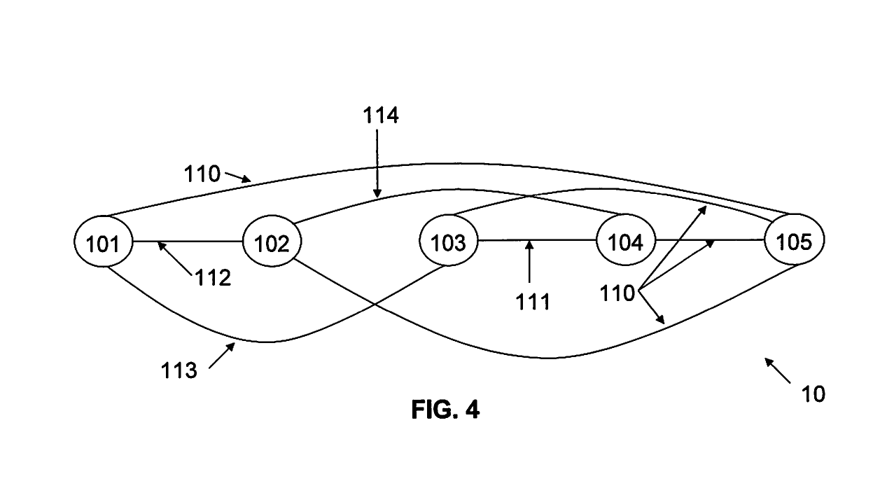

The system may include an interface which collects elements of clinician and patient data. The interface may be a keyboard, a touch screen, an integrated system 1105 (FIG. 2), or any other known means for interfacing with a processor. The integrated system 1105 may be part of a network 1200 (FIG. 3) which couples integrated system 1105 to processor 1002.

Integrated system 1105 may automatically collect patient data and transmit the patient data to processor 1002. Integrated system 1105 may collect the patient data directly from medical or bedside devices 1205 which may be attached to patients. Integrated system 1105 may interface with medical devices 1205 manufactured or produced by different companies using different data protocols and convert the patient data from each medical device 1205 into machine independent data for the medical institution. The machine independent data may be stored in centralized data repository 1230.

The system may include a network 1200 and a network interface 1016 coupling processor 1002 to network 1200. Network 1200 may include a first trusted network 1210 and a second trusted network 1290 connected to first trusted network 1210 by a wide-area network 1260. Each component of the system may be part of either first trusted network 1210 or second trusted network 1290. In some embodiments, the data transmitted between first trusted network 1210 and second trusted network 1290 through wide-area network 1260 is encrypted or secured such that the data is only decipherable by components within each trusted network 1210, 1290.

Mass storage component 1018 may be coupled to processor 1002 and may store social graph 10. Mass storage component 1018 may be a single mass storage device such as a hard drive or a solid-state drive. Mass storage component 1018 may also be an array of mass storage devices. Mass storage component 1018 may be part of central data repository 1230. Mass storage component 1018 may be part of second trusted network 1290 and processor 1002 may be part of first trusted network 1210.

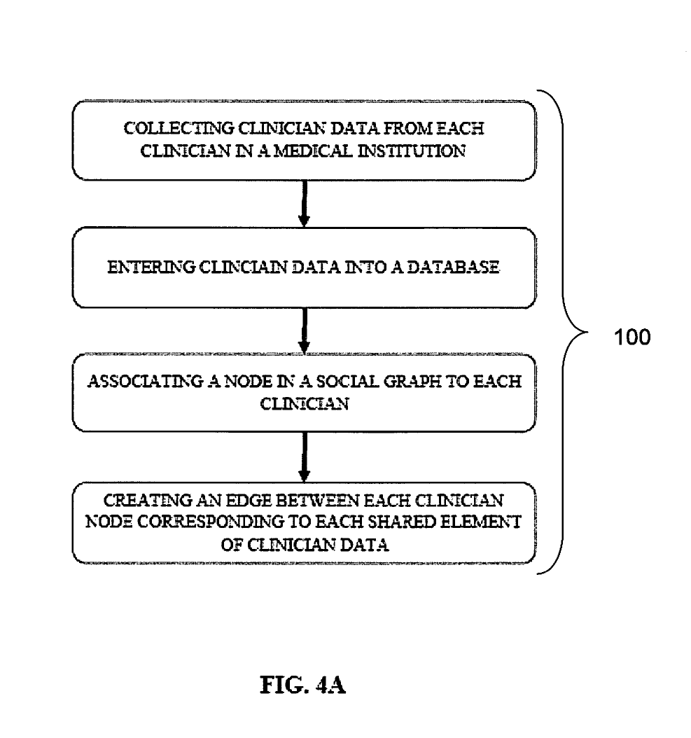

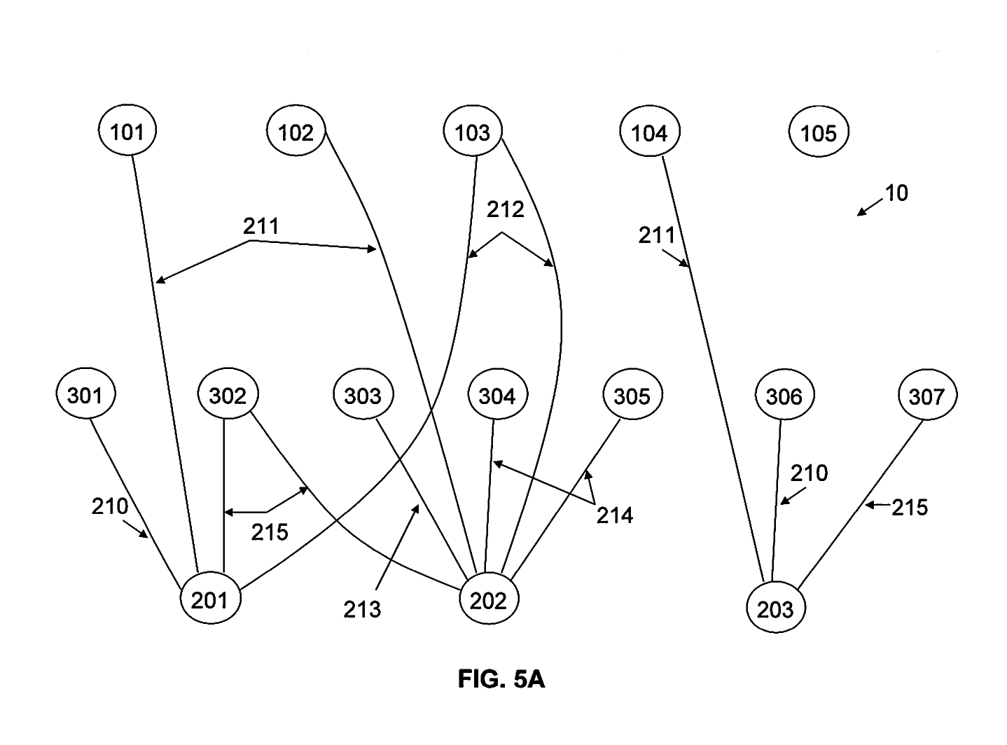

FIG. 4 depicts a portion of a social graph 10 according to at least one embodiment of the present disclosure. FIGS. 4, 5A, 5B, 6 and 7, depict portions of the social graph 10, one of skill in the art will understand that the social graph 10 of the current disclosure is in actuality a composite of FIGS. 4, 5A, 5B, 6 and 7, and are shown here separately for ease of understanding the many node types and the edges that can be formed between them.

FIG. 4A illustrates an embodiment of a method 100 which may be used to create the portion of social graph 10 depicted in FIG. 4. First, clinician information or data is collected from each clinician in a medical institution. The clinician information may include degrees earned, medical schools attended, areas of research, papers published, years practicing, position within the institution, certifications, and areas of specialty. The clinician information is then entered into a database. Next, each clinician is associated with a node in social graph 10 (i.e. clinician nodes) 101, 102, 103, 104, and 105. Then, an edge 110, 111, 112, 113, 114 may be created between each clinician node 101-105 for each organizational relationship, each professional relationship, each identified non-professional relationship, or each common element of clinician data. It will be appreciated, that as new clinicians join the medical institution additional clinician nodes may be created in social graph 10. It will also be appreciated, that existing clinicians may form new relationships, modify existing relationships, or modify clinician information which may facilitate the creation or modification of edges in social graph 10.

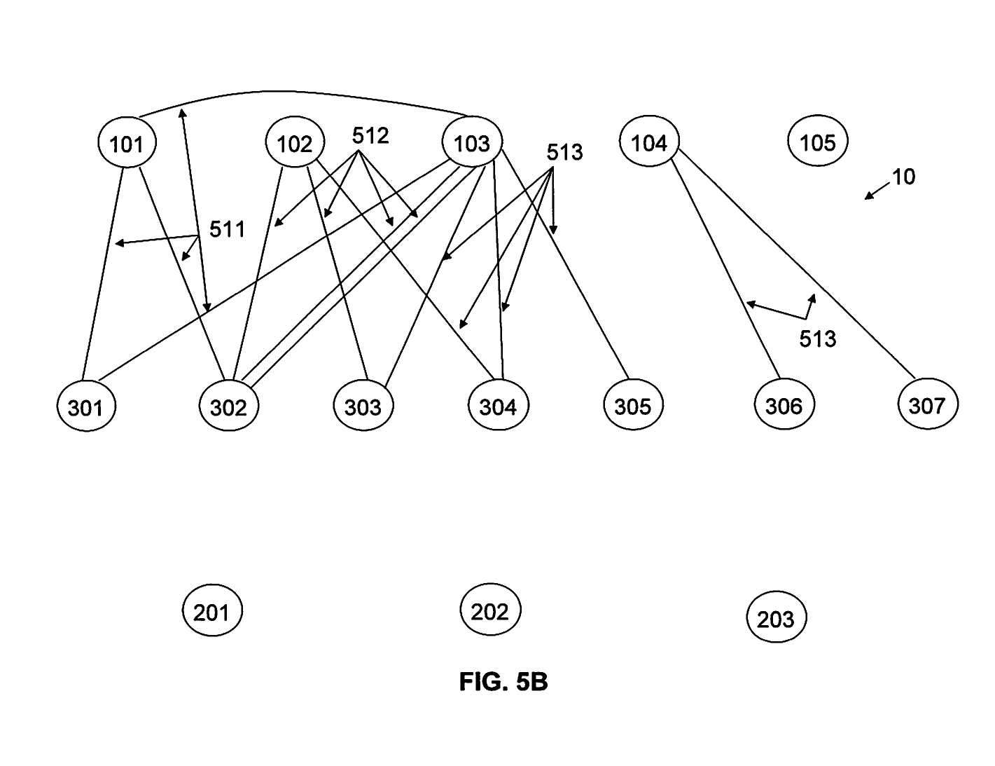

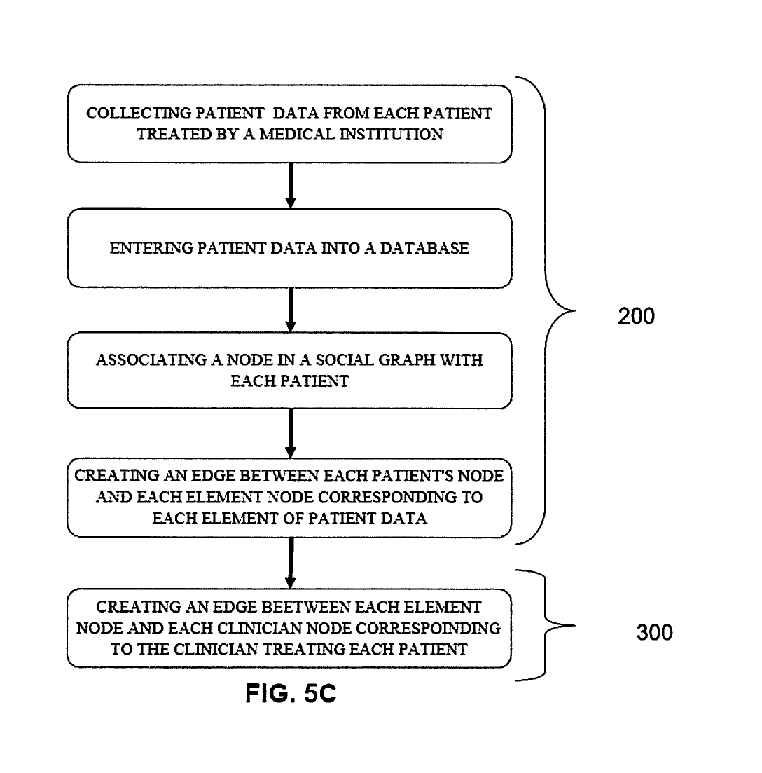

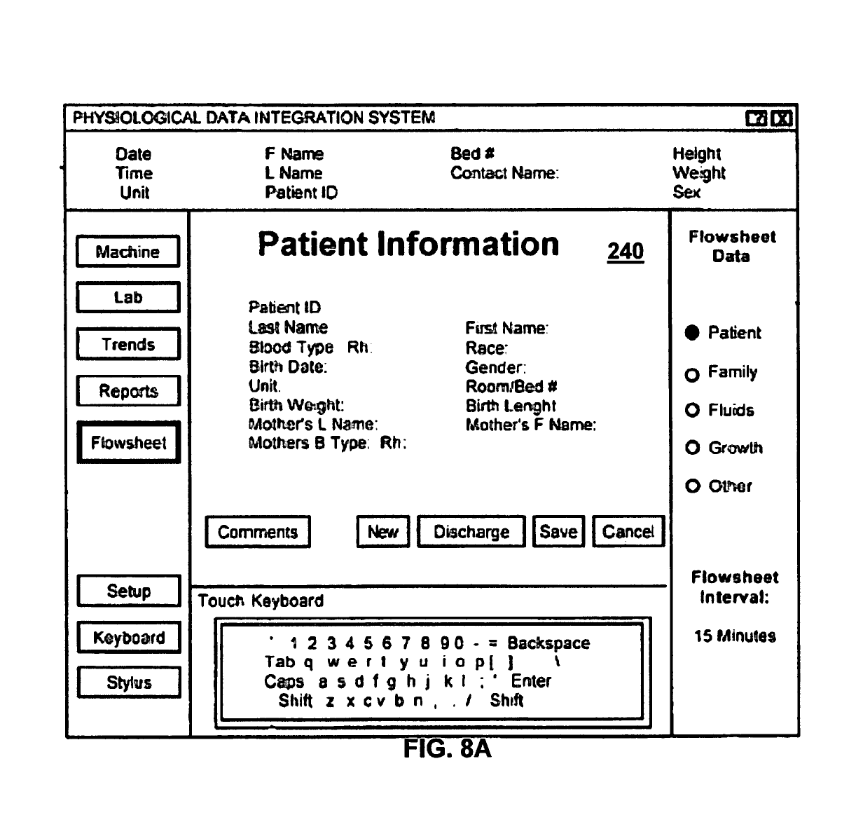

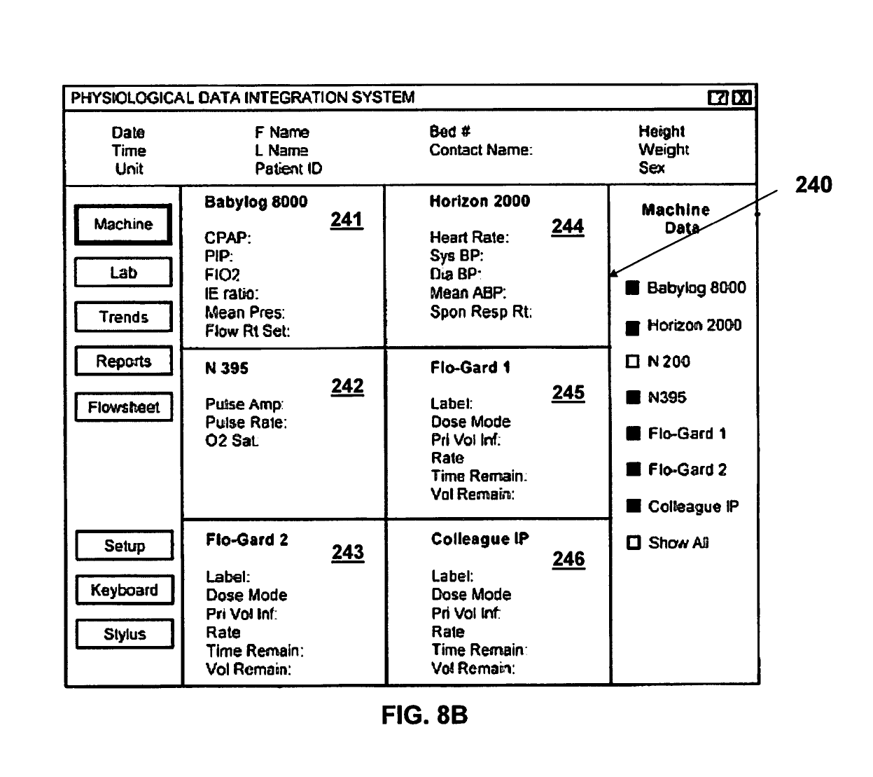

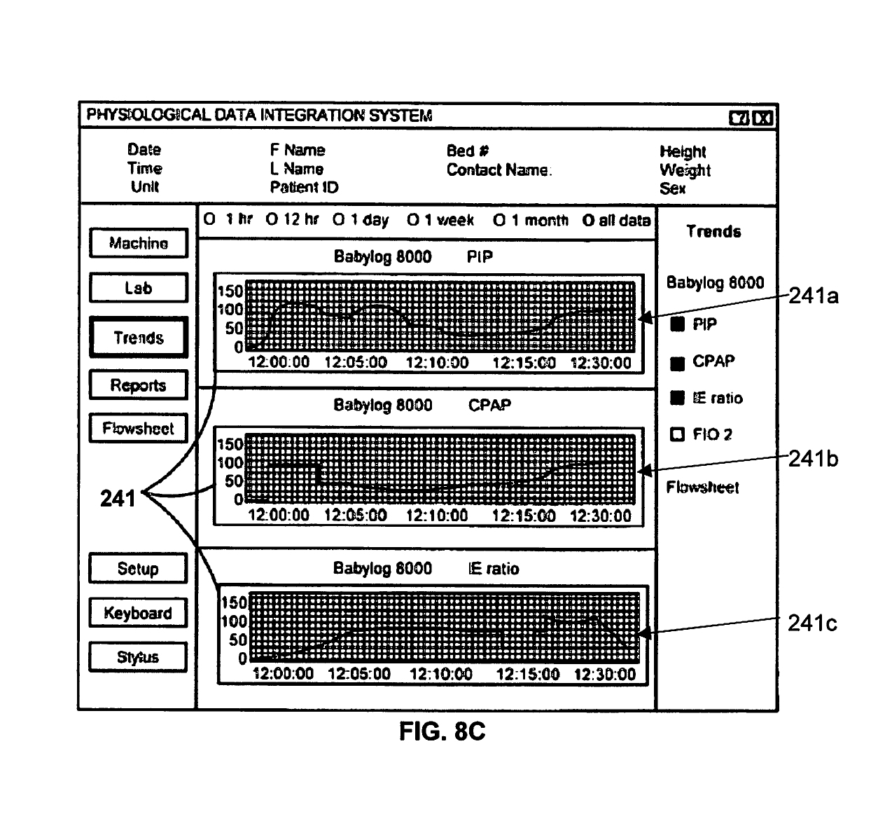

FIG. 5A illustrates a portion of social graph 10 which may be created by method 200 shown in FIG. 5C. Patient data is collected from patients being treated by the medical institution. The patient data includes elements 240 which may include a treating clinician, a reported condition, a set of physiological data, a set of medical device settings, a course of treatment, and/or a reaction to the course of treatment. The patient data may be manually written on a chart (not shown) and then entered into computer system 1000, or entered directly to computer system 1000 using a GUI as shown in FIG. 8A. Elements 240 of patient data may include machine settings from medical devices as shown in FIG. 8B. Elements 240 of patient data may also be captured directly by computer system 1000 from a medical device as shown in FIG. 8C. The patient data may also be entered in any combination of the above methods disclosed or other known methods.

Like the clinicians 101-105, discussed above, each individual patient may also be associated with a patient node 201, 202. 203, as shown in FIG. 5A. In addition, elements of patient data may also be associated with their own nodes 301-307. For example, element nodes relating to patient data may represent a course of treatment, a disease from which they are suffering, or other categories which might be beneficial to define as their own node. Element nodes 301-307 may also be a combination of patient data such as a condition being treated with a particular prescribed treatment. An edge is created between each patient node 201-203 and each corresponding element node 301-307 contained within the patient data as shown in FIG. 5A and illustrated as edges 210, 211, 212, 213, 214, and 215. Edges may be created between clinician nodes and patient nodes which directly connect a clinician with patient as illustrated by edges 211 and 212. These edges can represent formal treatment assignments made by the medical institution or by informal means such as consultations called for by treating clinicians.

A method 300 may also be employed to create an edge between each element node 301-307 and each clinician node 101-105 corresponding to the clinician assigned or treating the patient as shown in FIG. 5B and illustrated as edges 511, 512, and 513. Thereby, associating the treating clinician with each element of patient data for each patient under the care of the clinician.

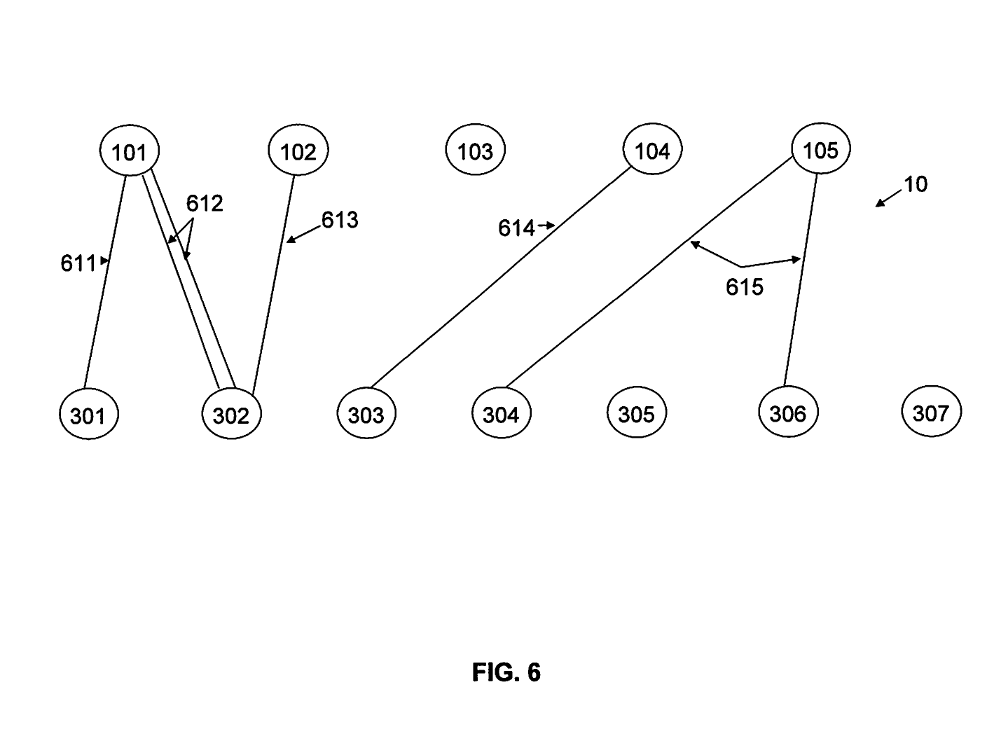

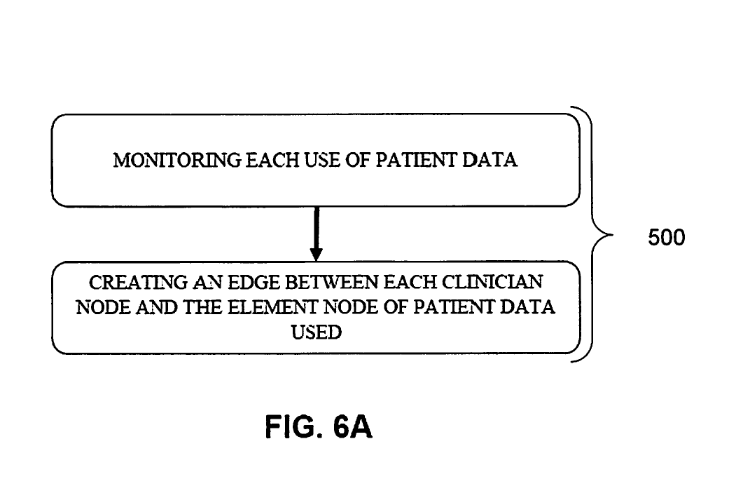

Edges may also be created by a method 500 shown in FIG. 6A and illustrated in FIG. 6. Each usage of patient data by each clinician is monitored by computer system 1000. Computer system 1000 creates an edge between each clinician node 101-105 and each element node 301-307 used by the clinician illustrated as edges 611, 612, 613, 614, and 615. Each usage may include a prescribed course of treatment for a patient, an update to the patient data, a search of the patient data, and an inquiry of a patient's information.

In an embodiment of this disclosure, social graph 10 may be used to identify or create a team of clinicians associated with elements of patient data. Social graph 10 may contain edges between clinician nodes and edges between element nodes and clinician nodes that may not be readily apparent to the medical institution. By utilizing social graph 10 to identify or create teams of clinicians, patients treated by the medical institution may experience improved care and improved outcomes.

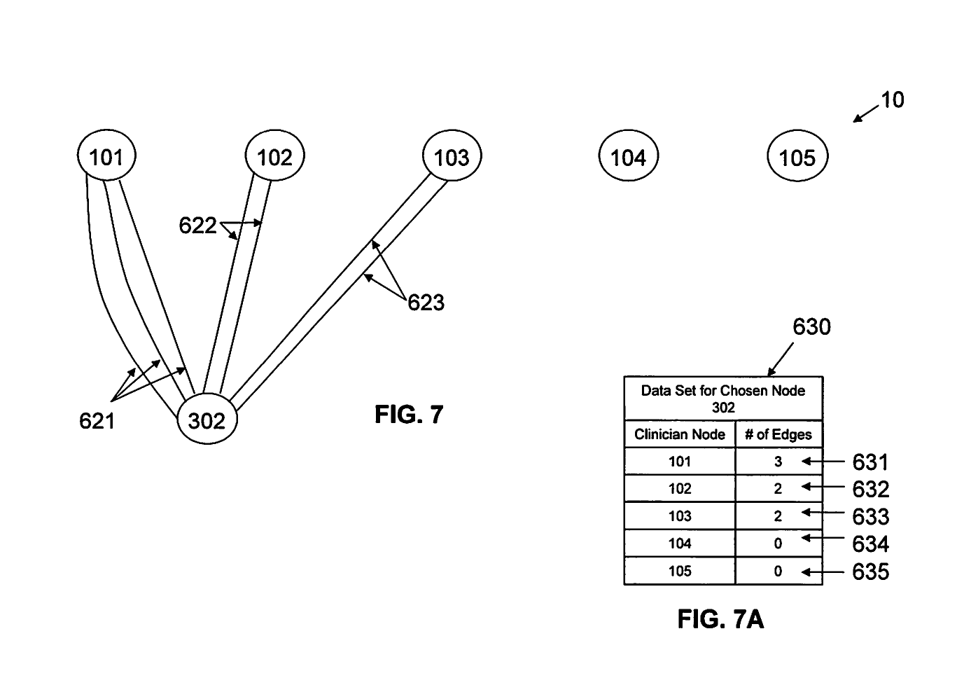

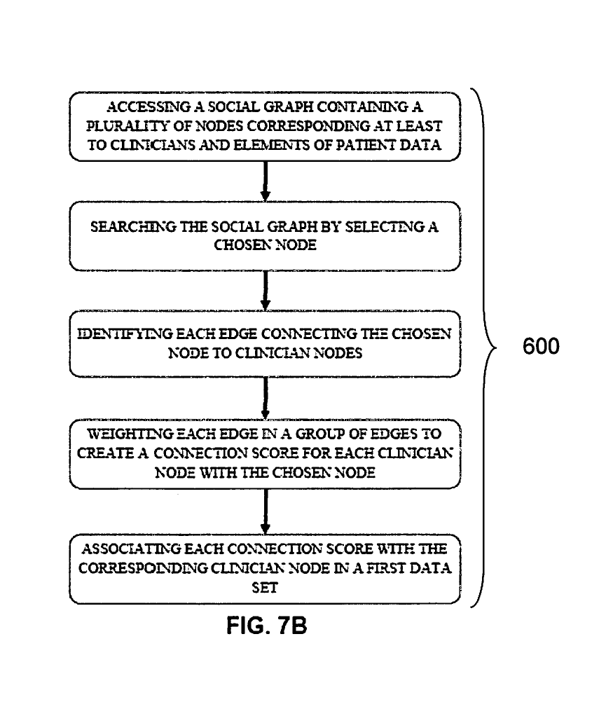

Referring now to FIGS. 7-7B, a method 600 is used to identify or create a team of clinicians using a first data set 630 from social graph 10. Method 600 may include accessing social graph 10 having a plurality of nodes and a plurality of edges. It will be appreciated that social graph 10 may continually evolve as nodes and edges are created by at least the methods 100, 200, 300, 500 described above. Method 600 may include selecting a chosen node 302 from the plurality of nodes in social graph 10. In the following example, an inquiry or search of social graph 10 is used identify or create a team of clinicians relates to chosen node 302 which corresponds to element node 302. The chosen node 302 is selected from any of the plurality of nodes. The chosen node 302 may be selected by direct input by a searching individual or the chosen node 302 maybe selected automatically by computer system 1000 using an algorithm. The searching individual may be a searching clinician, a searching administrator at the medical institution, searching patient, or searching elements (e.g., a treatment regimen). The chosen node 302 may be an element attributed to a patient that is being treated or researched by the searching individual. The chosen node 302 may be selected to form a team of clinicians to treat or research an element attributed to a patient or patients of the medical institution. The chosen node 302 may be selected based on a similarity of the usage of patient data by one or more clinicians.

Next, each edge connecting the chosen node 302 to each clinician node 101-105 is identified. The edges may be grouped 621, 622, 623 representing each connection between chosen node 302 and each clinician node 101-105. A score 631, 632, 633, 634, 635 is then created to represent the relevance or strength of the connection between each clinician node 101-105 and chosen node 302. Each edge may be weighted by the relevance of the method 100, 200, 300, 500 which created the edge. A weight may be assigned, using computer system 1000, to each edge within the group of edges 621, 622, 623 connecting each of the plurality of nodes 101-105, 201-203, and 301-307. For example, the weight may be based on the number of edges between each of the plurality of nodes. Alternatively, the weight given to each edge may also account for the number of inquiries by a single clinician, the time that has elapsed from when the edge was created, or the type of usage that created the edge. The effect of this weighting may be represented in a graphic user interface (GUI) viewable by the clinician. For example, if the inquiry by the clinician is with respect to other treatments being employed in a particular medical facility, a treatment option (element node 301-307) that has multiple edges connecting many patients and other physicians may be given a greater weight, and therefore a higher ranking in the results to the inquiry.

In some embodiments, the chosen node 302 includes multiple chosen nodes of the plurality of nodes. The first data set 630 scores each connection between clinician nodes 101-105 and each of the multiple chosen nodes. The score is represents the relevance or strength of the connection between each clinician node 101-105 and each of the multiple chosen nodes. In certain embodiments, the algorithm performs the calculations in aggregate for each of the multiple chosen nodes in a single process which results in a single data set.

According to embodiments of the present disclosure, a factor may be used to weight each edge within a group of edges. The factor may reflect the relevance of the edge. An exemplary example is the amount of time that has passed since the edge was created. The factor may be reduced as the amount of time increases from a range of about 1 to about 0. The factor may be represented as a percentage with 1 or 100% being most relevant to 0 or 0% being not at all relevant. Different criteria may be used to determine a factor for each edge or group of edges. Again, this factor may alter the ordering or importance given to results from an inquiry of the system that may be presented to the clinician following such an inquiry. Alternatively, the GUI viewable by a clinician participating in the system described herein, may be more closely tied to depicting the social graph 10, in such instances the weight of a connection may be displayed by differing line types. Bold colored solid lines may depict connection of greater weight and therefore of greater relevance to the clinician, whereas dotted lines may depict only tangential or lower relevance connections between clinician, patient, and element (e.g., treatment regimen) nodes.

First data set 630 represents the weight of each group of edges 621, 622, 623 connecting each clinician node 101-105 to the chosen node 302. In this example, first data set 630 includes scores 631, 632, 633, 634, and 635 corresponding to clinician nodes 101, 102, 103, 104, and 105 as shown in FIG. 7A. It will be appreciated that the score for clinician nodes 104 and 105 is zero, representing no connection between clinicians 104 and 105 and the chosen node 302. Weighting may also be configurable by a user of the system, so that a user can prioritize factors (represented by edges) in order of importance to a given institution. For example, one institution may consider professional affiliations more important than organizational relationships, but the reverse may be true at another institution. Edges representing those factors can be configured with differing weights at the two institutions.

A clinician team is then formed using first data set 630. Each clinician having a score 631, 632, 633, 634, 635 over a threshold score is displayed. The threshold score may be selected and inputted by the searching individual or automatically selected by computer system 1000. The threshold score represents a required strength or relevance of the connection between each clinician and the chosen node 302. In this example, the threshold score is 1. Accordingly, only the clinicians corresponding to clinician nodes with scores over 1 in first data set 630 will be displayed.

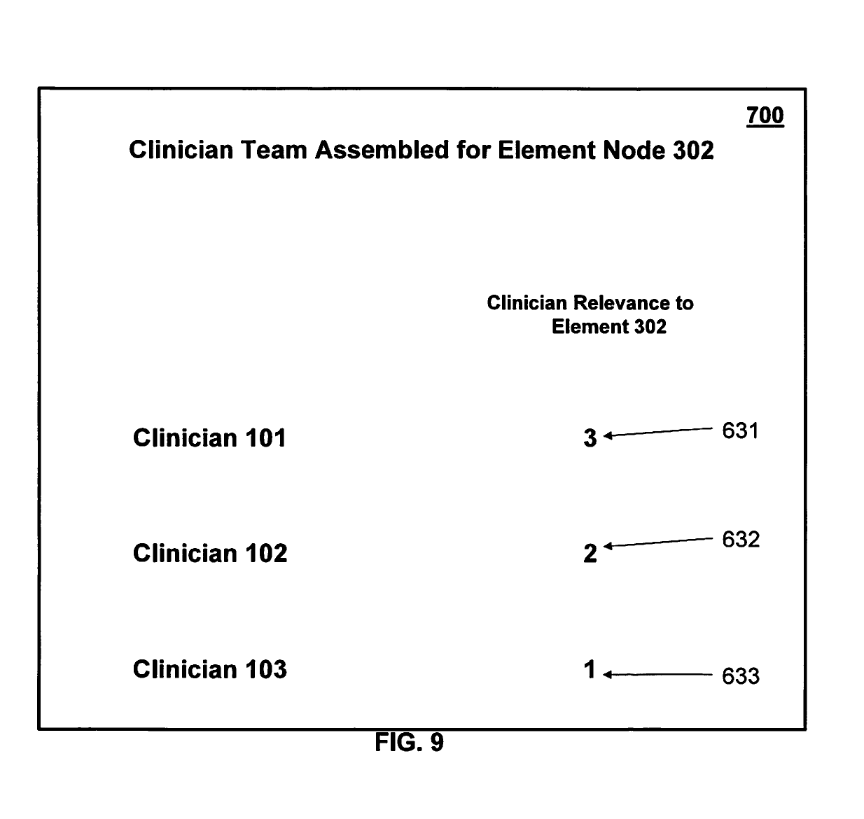

The display may be in the form of a screen display 700 (FIG. 9), an email, a text, a fax, a phone call, a printed page, or any other known means of communication. The display may also rank each clinician displayed by the score of the corresponding clinician node in first data set 630 as shown in FIG. 9.

Some embodiments involve the use of an algorithm running on computer system 1000 to identify potential members of teams of clinicians for a particular purpose. It is contemplated that this will be particularly useful where the clinicians themselves have a low connection score between each other (i.e., clinician nodes 101-105), but have a high connection score with a chosen node (e.g., a patient node 201-203, or an element node 301-307). This may be particularly useful in instances where common or well known treatment options have been less than completely successful and research regarding further treatment options is desired. One way of conducting such research might be by searching for clinicians treating the identified disease, and then identifying different treatment regime nodes. The algorithm may run continually or run at specified times. In one embodiment the algorithm creates a second data set that scores each connection between each clinician node. The algorithm identifies a score in the second data set is below a desired score. The low score signifies a weak or non-existent relationship between a first clinician and a second clinician, for example they are associated with different medical facilities, in different countries, or are in different disciplines. The algorithm then searches social graph 10 for a chosen node (e.g., disease type) having a first data set 630 where both the first clinician and the second clinician have a sufficiently high score. In this embodiment, the first and second clinicians are displayed along with their connections to the chosen node.

It is contemplated that the formation of formal and informal organizational relationships that develop may also be particularly useful in the establishment of previously unidentified relationships between clinicians. Prior to identification by the algorithm these relationships may not be readily apparent to an observer but, if developed, may provide value in terms of patient care, the advancement of clinical knowledge, or the optimization of institutional structures. For example, an observer may assume that a strong relationship exists between one clinician and a second clinician because they practice in the same discipline and within the same division of an organizational structure. A third clinician may practice in a different discipline and within a different organizational division than the first clinician, leading an observer to assume a weak or non-existent relationship between the first and third clinicians. The algorithm may identify that the total score of a large number of low-weighted edges between nodes (e.g. treatment regimens, patients, and professional interests) shared by the first and third clinicians may exceed the score of the single high-weighted edge representing the existing formal organizational relationship shared by the first and second clinicians. This detection of a previously unknown relationship may be used to restructure the organization to bring the first and third clinicians, and other similarly related clinicians detected by the algorithm, into more formal relationships. This knowledge may also be used less formally, as when bringing the first and second clinicians, and other similarly related clinicians detected by the algorithm, into teams convened around a particular patient for the duration of a particular condition or treatment plan.

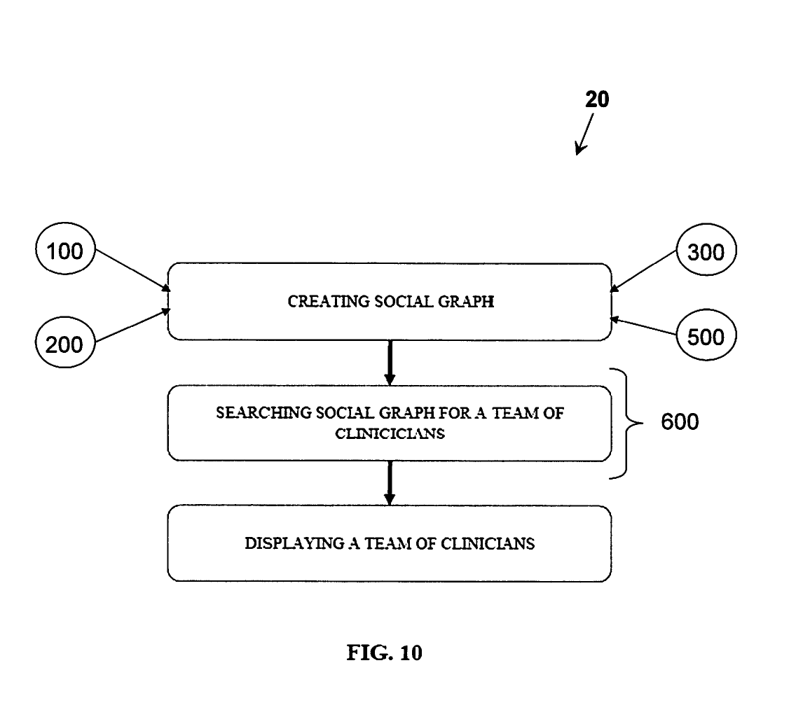

FIG. 10 illustrates a method 20 for creating a identifying a team of clinicians. Method 20 includes creating a social graph 10 having a plurality of nodes. The social graph may include nodes created by methods 100, 200, 300, or 500. Social graph 10 is then searched to identify a team of clinicians associated with a chosen node of the plurality of nodes. Method 600 may be used by method 20 to create a first data set corresponding to the chosen node. Method 20 may identify a team of clinicians by displaying each clinician with a score in the first data set over a threshold score, as described above.

In some embodiments, method 600 is repeated with multiple chosen nodes of the plurality of nodes. Method 20 may be applied to identify a team of clinicians by displaying each clinician with a combined score from the multiple data sets that exceeds a threshold score, as described above. In certain embodiments, the algorithm performs the calculations involving the multiple chosen nodes in aggregate which results in a single data set.

As a result, networks of clinicians, patients, diseases, treatment options, and other elements can be correlated and made available to individual clinicians, administrators, and even patients. Other uses may include identifying other clinicians treating an individual patient, identifying clinicians who are particularly skilled with a treatment regimen, identifying connections based on schooling, discipline, alternative treatments, etc., automatically assigning clinician teams for a patient, developing larger multi-disciplined clinician networks and others as will be understood by those of skill in the art.

The various GUIs disclosed herein are shown for purposes of illustration only. Accordingly, the present disclosure is not limited by the particular GUI or data entry mechanisms contained within views of the GUI. Rather, those skilled in the art will recognize that any of a variety of different GUI types and arrangements of data entry, fields, selectors, and controls can be used to access system. Further, the computing devices depicted herein can be functionally and/or physically implemented with other computing devices and the disclosure should not be limited by the particular exemplary configuration shown.

The present disclosure can be realized in hardware, software, or a combination of hardware and software. The present disclosure can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein.

The present disclosure also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This disclosure can be embodied in other forms without departing from the spirit or essential attributes thereof. Accordingly, reference should be made to the following claims, rather than to the foregoing specification, as indicating the scope of the disclosure.

What is claimed:

1. A method for identifying clinician teams comprising:
accessing, by one or more computer systems, a social graph with a plurality of nodes having a clinician node for each clinician of an institution and at least an edge between each clinician node corresponding to each organizational relationship and each professional relationship between each clinician;
collecting at least one element of patient data for each of a plurality of patients treated by the institution;
associating, by the one or more computer systems, each of the plurality of patients with a patient node and creating an edge between each patient node and an element node corresponding to each element of patient data, the one or more computer systems creating an edge between each element node of corresponding patient data with each clinician node corresponding to each clinician treating the patient;
monitoring, by the one or more computer systems, each usage of the patient data by each clinician and creating an edge between each clinician node corresponding to the clinician using the patient data and each element node of patient data used;
assigning, by the one or more computer systems, a weight to each connection between each of the plurality of nodes relating at least to the number of edges between each of the plurality of nodes;
creating, by the one or more computer systems, a first data set that scores each clinician node that is connected to at least one chosen node of the plurality of nodes by the weight of the connection between the clinician node and the at least one chosen node; and
displaying, by the one or more computer systems, each clinician corresponding to a clinician node having a score over a threshold score in the first data set.

2. The method according to claim 1, wherein the patient data includes at least one of a treating clinician, a reported condition, a set of physiological data, a set of medical device settings, a course of treatment, or a reaction to the course of treatment.

3. The method according to claim 2, wherein at least one of the set of physiological data and the set of medical device settings are automatically received from at least one medical device.

4. The method according to claim 1, wherein the each usage includes at least one of a prescribed course of treatment for a patient, an update to the patient data, a search of the patient data, or an inquiry of the patient data.

5. The method according to claim 1, wherein the threshold score varies by the weight of the connection between at least two clinician nodes within the first data set.

6. The method according to claim 1, wherein a clinician team is automatically formed from each clinician displayed.

7. The method according to claim 1, wherein displaying includes at least one of emailing, outputting to a display device, or texting.

8. A system for identifying clinician teams comprising:
a processor;
a mass storage component coupled to the processor and storing a social graph with a plurality of nodes having a clinician node for each clinician of an institution and at least an edge for each organizational relationship and for each professional relationship between each clinician;
at least one interface which collects at least one element of patient data for each of a plurality of patients treated by the institution, the processor associates each of the plurality of patients with a patient node and creates an edge between each patient node and an element node corresponding to the element of patient data, the processor creates an edge between each element node and the clinician node of each clinician treating the patient; and
a display,
wherein the at least one interface is monitored by the processor which creates an edge between each clinician node corresponding to the clinician using the patient data and each element node of patient data used, the processor assigns a weight to each connection between each of the plurality of nodes by at least the number of edges between each of the plurality of nodes, the processor creates a first data set that scores each clinician node that is connected to at least one chosen node of the plurality of nodes by the weight of the connection between the clinician node and at least one chosen node, the processor displays each clinician corresponding to each clinician node over a threshold score in the first data set.

9. The system according to claim 8, furthering including an integrated system coupled to the processor for automatically collecting the patient data.

10. The system according to claim 9, wherein the integrated system is coupled to the processor by a network.

11. The system according to claim 10, wherein the network includes a first trusted network which is connected to a second trusted network by a wide-area network, wherein only the first trusted network and the second network can decipher data transmitted through the wide-area network.

12. The system according to claim 11, wherein the processor is in the first trusted network and the mass storage component is in the second trusted network.

13. The system according to claim 8, wherein the processor displays each clinician on a display device.

14. The system according to claim 8, wherein the processor runs an algorithm that creates a second data set that scores each connection between each clinician node and every other clinician node, the algorithm identifies at least two clinician nodes each having a score in the second data set that is below a desired score, the algorithm searches the social graph for a chosen node having a first data set where each of the at least two clinician nodes are over the threshold score, wherein the processor displays each of the clinicians corresponding to that at least two clinician nodes and the chosen node having a first data set where each of the at least two clinician nodes are over the threshold score.

15. A computer readable medium having embodied thereon a program, the program being executable by a processor for performing a method for identifying a clinician team, the method comprising:
accessing, by one or more computer systems, a social graph with a plurality of nodes having a clinician node for each clinician of an institution and at least an edge between each clinician node corresponding to each organizational relationship and each professional relationship between each clinician;
collecting at least one element of patient data for each of a plurality of patients treated by the institution;
associating, by the one or more computer systems, each of the plurality of patients with a patient node and creating an edge between each patient node and an element node corresponding to each element of patient data, the one or more computer systems creating an edge between each element node of corresponding patient data with each clinician node corresponding to each clinician treating the patient;
monitoring, by the one or more computer systems, each usage of the patient data by each clinician and creating an edge between each clinician node corresponding to the clinician using the patient data and each element node of patient data used;
assigning, by the one or more computer systems, a weight to each connection between each of the plurality of nodes relating at least to the number of edges between each of the plurality of nodes;
creating, by the one or more computer systems, a first data set that scores each clinician node that is connected to at least one chosen node of the plurality of nodes by the weight of the connection between the clinician node and the at least one chosen node; and
displaying, by the one or more computer systems, each clinician corresponding to a clinician node having a score over a threshold score in the first data set.

16. The computer readable medium of claim 15, wherein the patient data includes at least one of a treating clinician, a reported condition, a set of physiological data, a set of medical device settings, a course of treatment, or a reaction to the course of treatment.

17. The computer readable medium of claim 15, wherein the each usage includes at least one of a prescribed course of treatment for a patient, an update to the patient data, a search of the patient data, or an inquiry of the patient data.

18. The computer readable medium of claim 15, wherein assigning the weight further includes multiplying each edge by a factor for the amount of time that has passed since the edge was created.

19. The computer readable medium of claim 18, wherein the factor is reduced as the amount of time increases.

20. The computer readable medium of claim 19, wherein the factor ranges from 1 to 0.
